(19) United States
(12) Patent Application Publication
(10) Pub. No.: US 2011/0191402 A1
(43) Pub. Date: Aug. 4, 2011

(54) NETWORK SYSTEM, PROCESS-PROVIDING-SERVER SWITCHING METHOD, INFORMATION PROCESSING APPARATUS, AND VIRTUAL-MACHINE BUILDING METHOD

(75) Inventor: Yuji IMAI, Kawasaki (JP)

(73) Assignee: Fujitsu Limited, Kawasaki-shi (JP)

(21) Appl. No.: 13/013,879

(22) Filed: Jan. 26, 2011

(30) Foreign Application Priority Data
Feb. 2, 2010 (JP) 2010-021591

(51) Int. Cl. G06F 15/16; G06F 9/455

(52) U.S. Cl. 709/201; 718/1

(57) ABSTRACT

A network system includes a router that performs routing between a virtual private network and a local network, a creating unit that creates information related to a process that is provided by a local server, the local server being connected to the local network; a sending unit that sends the information created by the creating unit via the router; and a virtual-private server that receives the information and provides the process that is provided by the local server via the virtual private network.

### CROSS-REFERENCE TO RELATED APPLICATION

This application is based upon and claims the benefit of priority of the prior Japanese Patent Application No. 2010-021591, filed on Feb. 2, 2010, the entire contents of which are incorporated herein by reference.

### FIELD

The embodiments discussed herein are directed to a network system, a process-providing-server switching method, an information processing apparatus, and a virtual-machine building method.

### BACKGROUND

A technology is known that enables the acquiring of setting information that is used to connect a router to an internet service provider (ISP) via a network, thereby simplifying the setting process conducted by a user for connecting the router to the Internet. According to this technology, when the router is connected to a modem, the router accesses a broadband access server. After a RADIUS server determines the router to be authentic, a terminal authentication server determines whether the terminal is authentic. After that, the router acquires setting information that is used to connect the router to an ISP server from an ISP download server. The router updates itself with the acquired setting information. The router then connects itself to the ISP server in accordance with the setting information and acquires information, such as the HTML of a WEB page that is present on the Internet, via the ISP server (see, for example, Japanese Laid-open Patent Publication No. 2004-199652).

A technology is known that enables a system that includes a virtual machine in a cloud data center to be accessible from a client's intranet. A physical server included in the cloud data center activates a virtual machine that executes a client's job and thus the system provides terminals that are connected to the client's intranet (e.g., computers) with services that support the client's jobs. For related technologies, see, for example, Japanese Laid-open Patent Publication No. 2005-208999, Japanese Laid-open Patent Publication No. 2001-318797, Japanese Laid-open Patent Publication No. 2009-116859, and Japanese Laid-open Patent Publication No. 2003-330728.

According to these conventional technologies, an engineer at a cloud data center builds a system that includes a virtual machine to a logical design in accordance with client's needs. The client performs a setting process for connecting his/her terminal to the virtual machine in the cloud data center. This increases the operating load on both the engineer at the cloud data center and the client.

If a router is added to the client's intranet and, via the intranet and the router, the client's terminal automatically accesses the virtual machine included in the cloud data center, the operating load is reduced. However, if a process performed by a server to provide the client with a service on the intranet is to be shifted to the virtual machine included in the cloud data center, the shifting process may increase the operating load.

### SUMMARY

According to an aspect of an embodiment of the invention, a network system includes a router that performs routing between a virtual private network and a local network, an information creating unit that creates information related to a process that is provided by a local server, the local server being connected to the local network, a sending unit that sends the information created by the information creating unit via the router, and a virtual-private server that receives the information and provides the process that is provided by the local server via the virtual private network.

According to another aspect of an embodiment of the invention, a process-providing-server switching method includes creating information related to a process that is provided by a local server, the local server being connected to a local network, sending the created information via a router that performs routing between a virtual private network and the local network, and receiving the information and providing the process that is provided by the local server via the virtual private network.

According to still another aspect of an embodiment of the invention, a computer readable, non-transitory medium stores a process-providing-server switching program that causes a computer to execute a process including creating information related to a process that is provided on a local network by the computer that executes the process-providing-server switching program, and sending the created information to a predetermined device that is connected to a virtual private network.

According to still another aspect of the present invention, an information processing apparatus includes a receiving unit that receives information related to a process from a router connected via a virtual private network, the process being provided on a local network by a server that is connected via the router, a virtual-machine management unit that builds a virtual machine that provides the process that is provided by the local server, and a sending unit that sends information about the virtual machine to the router.

According to still another aspect of the present invention, a virtual-machine building method includes receiving information related to a process from a router connected via a virtual private network, the process being provided on a local network by a server that is connected via the router, building a virtual machine that provides the process that is provided by the local server, and sending information about the virtual machine to the router.

According to still another aspect of the present invention, a computer readable, non-transitory medium stores a virtual-machine building program which causes a computer to execute a process including receiving information related to a process from a router connected via a virtual private network, the process being provided on a local network by a server that is connected via the router, building a virtual machine that provides the process that is provided by the local server, and sending information about the virtual machine to the router.

The object and advantages of the embodiment will be realized and attained by means of the elements and combinations particularly pointed out in the claims.

It is to be understood that both the foregoing general description and the following detailed description are exemplary and explanatory and are not restrictive of the embodiment, as claimed.

### BRIEF DESCRIPTION OF DRAWINGS

FIG. 1 is a schematic diagram of a network system according to a first embodiment;

FIG. 2 is a schematic diagram of a network system according to a second embodiment;

FIG. 3 illustrates components of the database;

FIG. 4A is a block diagram of the hardware configuration of an IT cell;

FIG. 4B is a block diagram of the functional configuration of the router management unit of the management server;

FIG. 5A is a block diagram of the hardware configuration of the router;

FIG. 5B is a block diagram of the functional configuration of the router;

FIG. 6 is a block diagram of the hardware configuration of the server;

FIG. 7 is a flowchart of a process performed by the router;

FIG. 8 is a flowchart of a process performed by the router management unit;

FIG. 9 is a flowchart of a process performed by the IT-cell management unit;

FIG. 10 is a flowchart of a process performed by the IT cell that includes the virtual machine that activates the virtualizing control device; and

FIGS. 11 and 12 are a sequence diagram of a process performed by the information management system.

### DESCRIPTION OF EMBODIMENT(S)

Preferred embodiments of the present invention will be explained with reference to accompanying drawings. The present invention is not limited to the following embodiments.

### [a] First Embodiment

### System Configuration

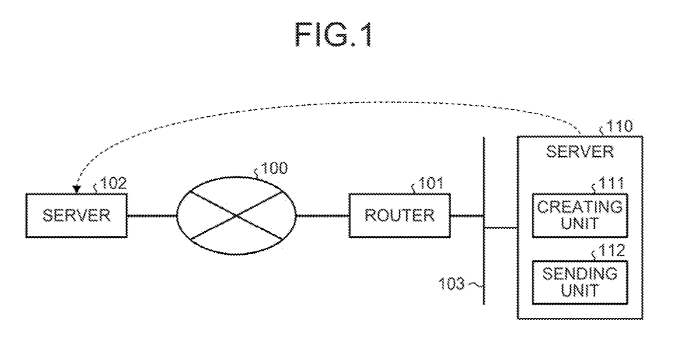

FIG. 1 is a schematic diagram of a network system according to a first embodiment. As illustrated in FIG. 1, a router 101 is connected to a network 100, which is a virtual private network, and a local network 103. The router 101 relays communications from an information processing apparatus that is connected to the local network 103 to an information processing apparatus that is connected to the network 100, which is the virtual private network, and vice versa.

The virtual private network or the network 100 is connected to a server 102. The local network 103 is connected to a server 110.

The server 110 includes a creating unit 111 and a sending unit 112. The creating unit 111 creates information related to a process provided by the server 110. The server 110 is a local server. The sending unit 112 sends the information created by the creating unit 111 to the server 102 via the router 101.

The server 102 that is connected to the virtual private network or the network 100 receives the information from the server 110 and provides the process that is provided by the server 110 via the virtual private network.

As described above, the process that is provided by the server 110 is shifted to the server 102. Therefore, a client's terminal that was connected to the local network 103 can use the same service as the service that is provided by the server 110 by accessing the server 102 via the router 101.

Summary of First Embodiment

As described above, in the network system according to the first embodiment, by creating information related to the process that is provided by the server 110 and sending the created information to the server 102, the existing server is easily replaced with a virtual machine. Creating and sending information related to a service that is provided by the server 110 can be performed when, for example, the server 110 executes a predetermined program. It is allowable to create information related to a service that is provided by the server 110 by a device different from the server 110 and send the information by the device.

### [b] Second Embodiment

### System Configuration

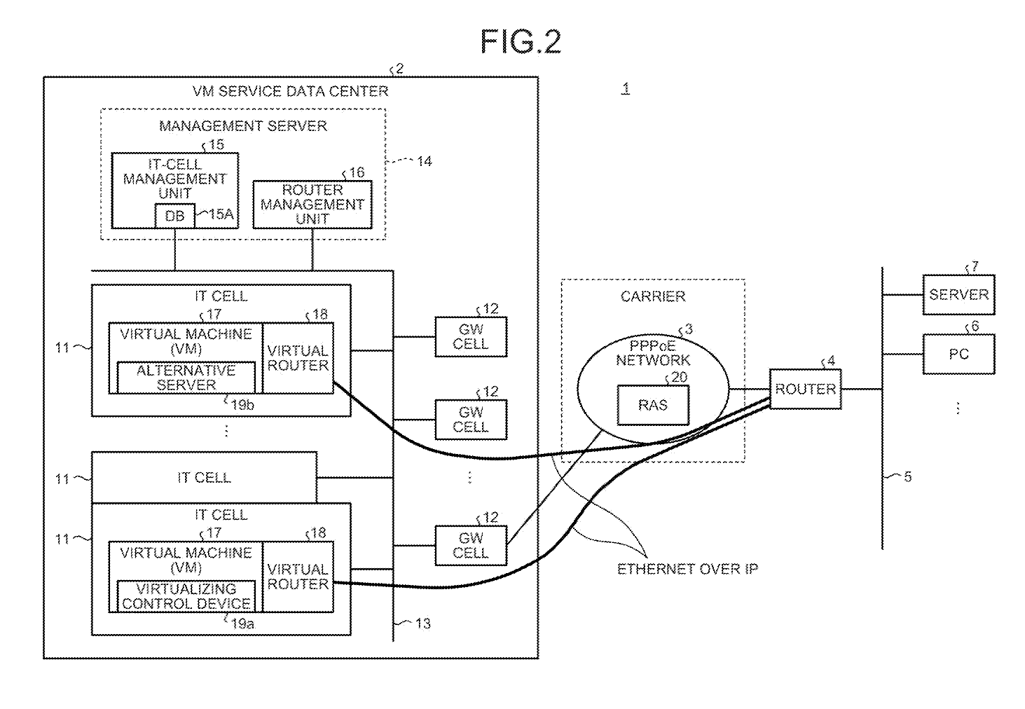

FIG. 2 is a schematic diagram of a network system according to a second embodiment. As illustrated in FIG. 2, an information management system 1 includes a virtual machine (VM) service data center 2, a Point to Point Protocol over Ethernet (PPPoE (Ethernet is registered mark)) network 3, a router 4, a client intranet 5, a client personal computer (PC) 6, and a server 7. The PPPoE network 3 is provided by a carrier.

PPPoE is a protocol that enables Point to Point Protocol (PPP) functions via the Ethernet (registered mark). PPPoE is used as a protocol for a later-described virtual private network. The PPPoE network 3 is a wide area network (WAN). The router 4 is a cloud computing router that connects the client PC 6 to the VM service data center 2. The router 4 can be directly connected to the client PC 6. The client PC 6 is an example of an external device. The server 7 is connected to the intranet 5 and provides the PC 6 that is connected to the intranet 5 with a predetermined service.

The VM service data center 2 is a cloud computing service center that provides the client PC 6 with services, such as a software package and a platform that is used to execute an application, via the PPPoE network 3. The VM service data center 2 includes a plurality of information technology (IT) cells 11, a plurality of gateway (GW) cells 12, and a management server 14. Each IT cell 11 is made up of a physical server. Each GW cell 12 is made up of a gateway server.

The management server 14 is connected to the IT cells 11 and the GW cells 12 via a local area network (LAN) 13. The IT cells 11 are examples of information processing apparatuses. The management server 14 is an example of an information management apparatus.

Each IT cell 11 includes a virtual machine that activates services that are provided for the client PC 6 and a virtual router 18 that controls output of data from a virtual machine 17 and input of data to the virtual machine 17. The virtual machine 17 is connected to the virtual router 18 in a one-to-one relation. The IT cell 11 can include two or more virtual machines 17 and two or more virtual routers 18. The virtual machine 17 has an activated virtual OS and an activated application that is provided for a client. The virtual machine 17 and the virtual router 18 are made up with software. The virtual router 18 is a fire wall router that accepts only accesses from some particular client PCs.

The GW cell 12 has a gateway program and executes the gateway program to transfer data between the virtual router 18 and the PPPoE network 3.

The management server 14 includes an IT-cell management unit 15 (management means) and a router management unit 16. The IT-cell management unit 15 includes a database (DB) 15A.

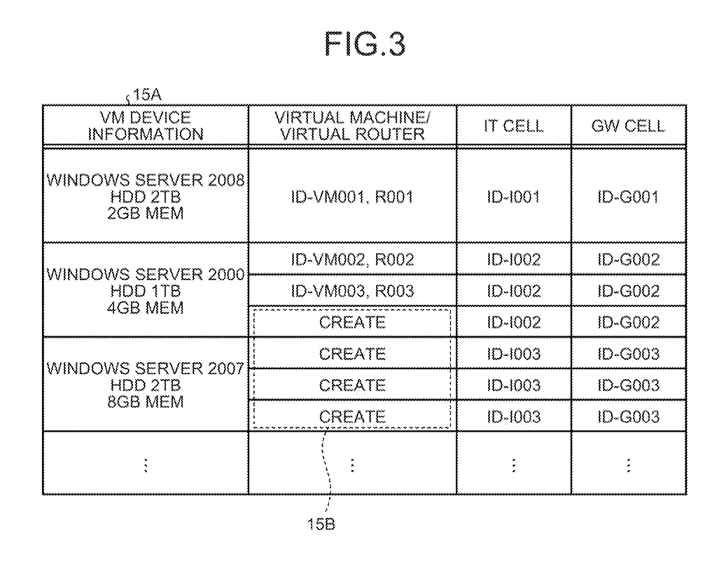

FIG. 3 illustrates components of the DB 15A. The DB 15A contains ID number of the virtual machine, ID number of the virtual router, ID number of the IT cell, and ID number of the GW cell that are assigned to VM device information that is received from the router 4. The VM device information is used to identify the IT cell 11 that activates the virtual machine 17 and the virtual router 18. More particularly, the VM device information is information about an operating system (OS) of the IT cell 11 and information about a hardware resource included in the IT cell 11. The VM device information is an example of information related to the information processing apparatus.

In the example of FIG. 3, the OSs are “windows server 2008”, “windows server 2000”, and “windows server 2007”. The hardware resources are “HDD 2 TB, 2 GB mem”, “HDD 1 TB, 4 GB mem”, and “HDD 2 TB, 8 GB mem”. As illustrated in FIG. 3, cells 15B of the DB 15A has “create”. This indicates that the IT cell 11 is to create a new virtual machine and a new virtual router 18.

Upon receiving the VM device information from the router 4, the IT-cell management unit 15 selects a virtual machine 17, a virtual router 18, an IT cell 11, and a GW cell 12 with reference to the DB 15A in accordance with the VM device information. The IT-cell management unit 15 activates the selected IT cell 11 and the selected GW cell 12. If the cell 15B of the DB 15A has “create”, the IT-cell management unit 15 registers the ID number of a new virtual machine 17 and the ID number of a new virtual router 18 to the DB 15A, creates the new virtual machine 17 and the new virtual router 18, and activates the new virtual machine 17 and the new virtual router 18.

The IT-cell management unit 15 manages the operation of each IT cell 11. The router management unit 16 builds a PPPoE communication session between the router 4 and the GW cell 12 on an IP-Virtual Private Network (IP-VPN) that is built by a carrier. The IP-VPN is a virtual private network (VPN) that is built via a wide area IP communication network of the carrier. The IP-VPN illustrated in FIG. 2 is a virtual private network (VPN) that connects the VM service data center 2 to the router 4 via the PPPoE network 3. The IP-VPN includes, for example, FLET'S VPN Wide and FENICS business IP network service both provided by the carriers.

The router management unit 16 sends the IP address of the virtual router 18 to the router 4, the IP address of the router 4 to the virtual router 18, and builds communications between the router 4 and the virtual router 18 using the Ethernet over IP. The router management unit 16 sends a request to the IT-cell management unit 15 to assign the GW cell 12 that executes a PPPoE communication session to the IT cell that activates the virtual machine 17. Although both the IT-cell management unit 15 and the router management unit 16 are included in the same management server, they can be included in different servers.

The carrier provides the PPPoE network 3 that works as an IP-VPN of optical communications (FTTH) between the VM service data center 2 and the router 4. The carrier has an RAS 20 that is a service for connecting a terminal to a remote computer network. The carrier executes a PPPoE communication session between the virtual router 18 and the router 4 using the RAS 20.

In the example illustrated in FIG. 2, one of the virtual machines 17 has a service of a virtualizing control device 19a activated. The virtualizing control device 19a builds the virtual machine 17 in response to a request received from the server 7 and sets the built virtual machine to be an alternative server 19b. The virtualizing control device 19a causes the alternative server 19b to perform the process that is provided by the server 7.

The server 7 sends a VM image to the virtualizing control device 19a as information related to the process that is provided by the server 7. The VM image includes the VM device information, such as information about the hardware resource included in the server 7 and information about the OS of the server 7, and an image of the HDD of the server 7.

The virtualizing control device 19a sends the received VM device information to the IT-cell management unit 15. The IT-cell management unit 15 activates the IT cell 11 and the GW cell 12 with reference to the DB 15A in accordance with the VM device information. The IT-cell management unit 15 registers the ID number of a new virtual machine 17 and the ID number of a new virtual router 18 to the DB 15A, creates a new virtual machine 17 and a new virtual router 18, and activates the new virtual machine 17 and the new virtual router 18.

In the information management system 1 that has the above configuration, when the client connects the router 4 to between the PPPoE network 3 and the client intranet 5 and the server 7 sends the VM device information to the VM service data center 2, the VM service data center 2 builds the alternative server 19b using the virtual machine. The alternative server 19b then provides the same service as the service of the server 7 and thus server replacement is performed, i.e., servers that provide the process are switched.

Device Configuration

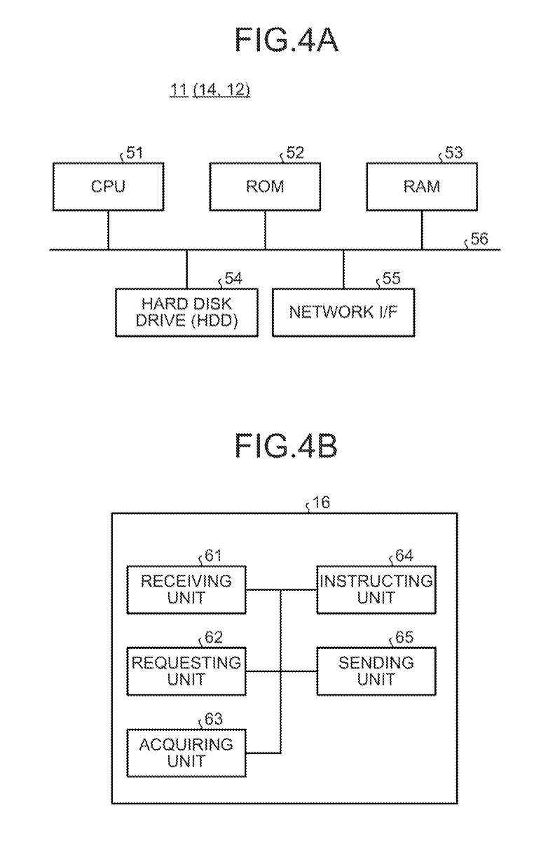

FIG. 4A is a block diagram of the hardware configuration of the IT cell 11. FIG. 4B is a block diagram of the functional configuration of the router management unit 16 of the management server 14.

As illustrated in FIG. 4A, the IT cell 11 includes a CPU 51 that controls the IT cell 11, a ROM 52 that has a control program, and a RAM 53 that works as a working area. The IT cell 11 further includes a hard disk drive (HDD) 54 that has various information and programs and a network interface (I/F) 55 that is used to connect the IT cell 11 to the LAN 13.

The CPU 51 is connected to the ROM 52, the RAM 53, the HDD 54, and the network I/F 55 via a system bus 56. The hardware configuration of the IT cells 11 is the same as those of the management server 14 and the GW cells 12; therefore, the hardware configuration of the management server 14 and the hardware configuration of the GW cells 12 are not described. It is noted that when the CPU 51 of the management server 14 executes a control program that is stored in either the ROM 52 or the HDD 54 of the management server 14, the IT-cell management unit 15 and the router management unit 16 illustrated in FIG. 2 are implemented. The DB 15A illustrated in FIG. 2 is included in the HDD 54 of the management server 14.

As illustrated in FIG. 4B, the router management unit 16 includes a receiving unit 61, a requesting unit 62, an acquiring unit 63, an instructing unit 64, and a sending unit 65.

When the router 4 is connected to between the PPPoE network 3 and the client intranet 5, the receiving unit 61 receives VM device information from the router 4. The requesting unit 62 requests the carrier to create an operational phase IP-VPN and two sets of operational phase PPPoE setting information. The acquiring unit 63 acquires, in accordance with the VM device information, information about an IT cell 11 to be activated, a virtual machine 17 to be activated, a virtual router 18 to be activated, and a GW cell 12 to be activated included in the VM service data center 2. The information about the IT cell 11 is the ID number for identifying the IT cell 11. The information about the virtual machine 17 is the ID number for identifying the virtual machine 17. The information about the virtual router 18 is the ID number for identifying the virtual router 18. The information about the GW cell 12 is the ID number for identifying the GW cell 12.

The acquiring unit 63 further acquires two sets of operational phase PPPoE setting information from the carrier. The operational phase PPPoE setting information will be described later. The instructing unit 64 instructs the IT-cell management unit 15 to activate the virtual machine 17 and the virtual router 18 in accordance with the information about the virtual machine 17 to be activated and the information about the virtual router 18 to be activated. The sending unit 65 sends one set of the operational phase PPPoE setting information to the router 4 and the other set of the operational phase PPPoE setting information to the GW cell 12 in accordance with the information about the GW cell to be activated. Moreover, the sending unit 65 sends the IP address of the activated virtual router 18 to the router 4 and the IP address of the router 4 to the activated virtual router 18.

The receiving unit 61, the acquiring unit 63, the sending unit 65 are implemented by operation of the CPU 51 and the network I/F 55 of the management server 14. The requesting unit 62 and the instructing unit 64 are implemented, when the CPU 51 of the management server 14 executes a predetermined control program.

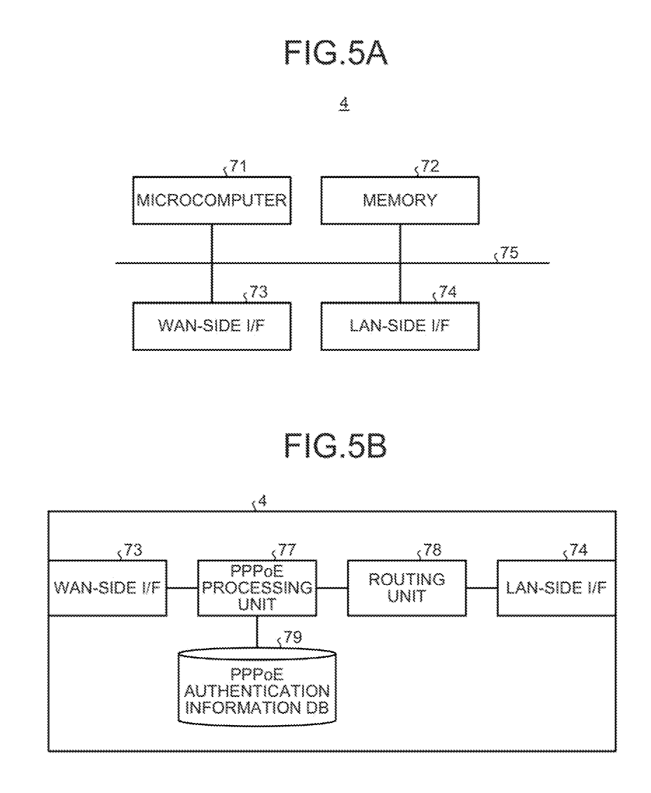

FIG. 5A is a block diagram of the hardware configuration of the router 4. FIG. 5B is a block diagram of the functional configuration of the router 4.

As illustrated in FIG. 5A, the router 4 includes a microcomputer 71 that controls the router 4 and a memory 72 that stores therein a control program and data. The router 4 further includes a wide area network (WAN)-side I/F 73 that is used to connect the router 4 to the PPPoE network 3 and a LAN-side I/F 74 that connects the router 4 to the client intranet 5. The microcomputer 71 is connected to the memory 72, the WAN-side I/F 73, and the LAN-side I/F 74 via a bus 75.

The memory 72 stores therein scripts, setting phase PPPoE setting information, and VM device information, those being used to connect the router 4 to a virtual machine. The setting phase PPPoE setting information includes the PPPoE user name and the password. The setting phase PPPoE setting information is used when the router 4 makes a first contact with the VM service data center 2 via the PPPoE network 3 using PPPoE. The PPPoE user name is, for example, “faucet-user-123456@facet.sop.fujitsu.com” and made up of the domain name for identifying the VM service data center 2 and the ID that is unique to the router 4. The VM device information that is stored in the memory 72 is the VM device information for identifying the IT cell 11 that has the virtualizing control device 19a activated. Therefore, the virtual machine 17 with which the server 7 makes a first access via the router 4 is the virtual machine 17 that activates the virtualizing control device 19a.

As illustrated in FIG. 5B, the router 4 includes a PPPoE processing unit 77, a routing unit 78, a PPPoE authentication information DB 79, the WAN-side I/F 73, and the LAN-side I/F 74. The PPPoE authentication information DB 79 stores therein the setting phase PPPoE setting information. The PPPoE authentication information DB 79 is included in the memory 72.

The PPPoE processing unit 77 performs a process for making a first contact with the VM service data center 2 via the PPPoE network 3 using the setting phase PPPoE setting information that is stored in the PPPoE authentication information DB 79. Moreover, the PPPoE processing unit 77 performs a process for making contact with the VM service data center 2 via the PPPoE network 3 using the operational phase PPPoE setting information. The operational phase PPPoE setting information includes the PPPoE-ID and the password that are used to connect the router 4 to the operational phase IP-VPN. The operational phase PPPoE setting information is acquired from the router management unit 16. The operational phase PPPoE setting information is an example of virtual-private-network protocol setting information. Two or more clients can access the VM service data center 2 at the same time using the same GW cell 12 during the setting phase; therefore, the router management unit 16 assigns a different GW cell 12 to each client at the operational phase, which increases the information security. This is because the setting phase PPPoE setting information is distinguished from the operational phase PPPoE setting information.

The routing unit 78 acquires the IP address of the virtual router 18 that is selected by the IT-cell management unit 15 from the router management unit 16 and makes communications with the virtual router 18 that is selected by the IT-cell management unit 15 using the Ethernet over IP. Thus, data communications using the Ethernet over IP are made between the server 7 and the virtual machine 17 that is selected by the IT-cell management unit 15. The Ethernet over IP is a function of converting data (more particularly, an Ethernet frame) to an IP packet and sending/receiving the IP packet. The PPPoE processing unit 77 and the routing unit 78 are implemented when the microcomputer 71 executes a control program that is stored in the memory 72.

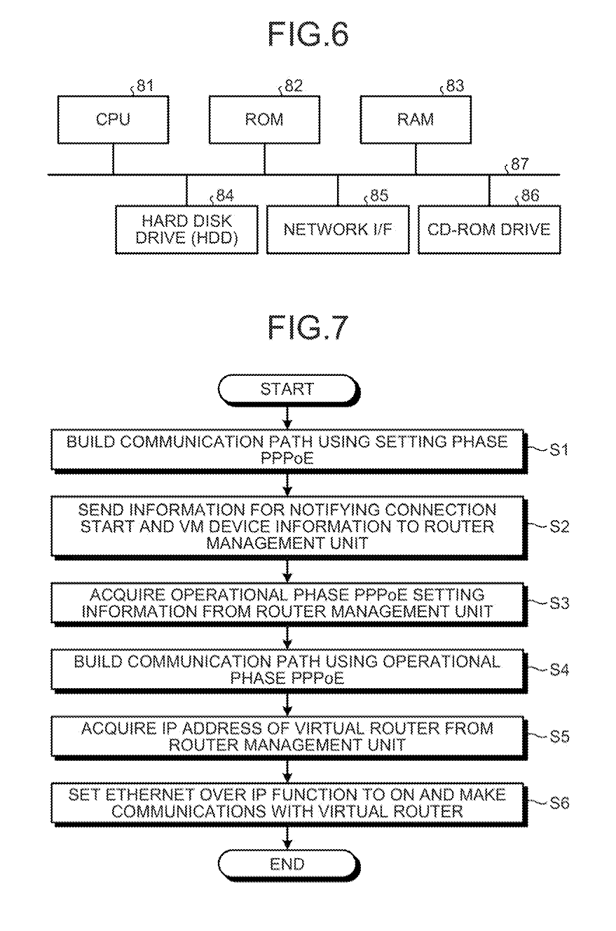

FIG. 6 is a block diagram of the hardware configuration of the server 7. As illustrated in FIG. 6, the server 7 includes a CPU 81 that controls the server 7, a ROM 82 that has a control program, and a RAM 83 that works as a working area. The server 7 further includes a hard disk drive (HDD) 84 that has various information and programs and a network I/F 85 that is used to connect the server 7 to the intranet 5. The server 7 further includes a CD-ROM drive 86 that reads data from a compact disk (CD)-ROM.

The CPU 81 is connected to the ROM 82, the RAM 83, the HDD 84, the network I/F 85, and the CD-ROM drive 86 via a system bus 87. When the CPU 81 executes the control program that is stored in the ROM 82 or the HDD 84, the server 7 provides the intranet 5 with a predetermined service.

Moreover, when the CPU 81 reads the control program from the CD-ROM drive 86 and executes the read control program, the server 7 creates information related to the server 7 and sends the information. The program that is stored in the CD-ROM causes the server 7 to perform processes of creating the VM device information using information about the hardware resource and information about the OS of the server 7, creating the HDD image using the HDD 84, and sending the VM image that contains both the VM device information and the HDD image.

Description about Process

FIG. 7 is a flowchart of a process performed by the router 4. It is assumed that the client connects an optical communication cable to the WAN-side I/F 73 of the router 4, a LAN cable to the LAN-side I/F 74, and then powers on the router 4.

The PPPoE processing unit 77 builds, using the setting phase PPPoE setting information that is stored in the PPPoE authentication information DB 79, a communication path to the GW cell 12 using the setting phase PPPoE, i.e., connects the router 4 to the setting phase IP-VPN (Step S1). After Step S1, the router 4 accesses the GW cell 12 of the VM service data center 2 via the PPPoE network 3.

The PPPoE processing unit 77 then sends both information for notifying connection start and the VM device information that is stored in the PPPoE authentication information DB 79 to the router management unit 16 (Step S2). The information for notifying connection start is, for example, a packet indicative of connection start. If the host name of the router management unit 16 is “faucet-mng.cloud.fujitsu.com”, the PPPoE processing unit 77 sends both the packet indicative of connection start and the VM device information to the address “http://faucet-mng.cloud.fujitsu.com”. The VM device information that is sent at Step S2 is the VM device information for identifying the IT cell 11 that has a Web server 19 activated.

As a response to the VM device information, the PPPoE processing unit 77 acquires the operational phase PPPoE setting information, i.e., the PPPoE-ID and the password from the router management unit 16 (Step S3). The PPPoE processing unit 77 builds, using the PPPoE-ID and the password acquired from the router management unit 16, a communication path to the activated GW cell 12 using the operational phase PPPoE, i.e., connects the router 4 to the operational phase IP-VPN (Step S4). After Step S4, the router 4 is connected to the activated GW cell 12 via the Ethernet-based virtual private network.

After that, the routing unit 78 acquires the IP address of the virtual router 18 that is selected by the IT-cell management unit 15 from the router management unit 16 (Step S5). For example, the routing unit 78 acquires the IP address of the virtual router 18 that is selected by the IT-cell management unit 15 from “http://faucet-mng.cloud.fujitsu.com/etherip-param” that is a site of the router management unit 16 where the IP addresses of the virtual routers 18 are registered. The IP address of the virtual router 18 that is selected by the IT-cell management unit 15 is the IP address of the virtual router 18 that is to be connected to the IT cell 11 that has the virtualizing control device 19a activated.

The routing unit 78 sets the Ethernet over IP function to on, the Ethernet over IP function being the function of converting data into an IP packet and sending/receiving the IP packet to/from the virtual router 18 that is selected by the IT-cell management unit 15. This results in a situation as if the router 4 was directly connected, via the Ethernet, to the virtual machine 17 or the virtualizing control device 19a that is connected to the virtual router 18 that is selected by the IT-cell management unit 15. At the same time, the routing unit 78 makes communications with the virtual router 18 that is selected by the IT-cell management unit 15 via the communication path from the activated GW cell 12 to the router 4 in accordance with the acquired IP address of the virtual router 18 (Step S6). Because the router 4 has a dynamic host configuration protocol (DHCP) and assigns the IP address to the client PC 6, the virtual machine 17 that activates the virtualizing control device 19a is connected to the client PC 6 via the virtual router 18 and the router 4. If the router 4 has a table of information and assigns the IP address of the router 4 to the IP address of the client PC 6 with reference to the table, it is unnecessary to have the DHCP.

As an effect of the processes from Steps S1 to S6, the server 7 can access the virtualizing control device 19a via the router 4, the PPPoE network 3 (IP-VPN), the GW cell 12, and the virtual router 18 using the Ethernet over IP.

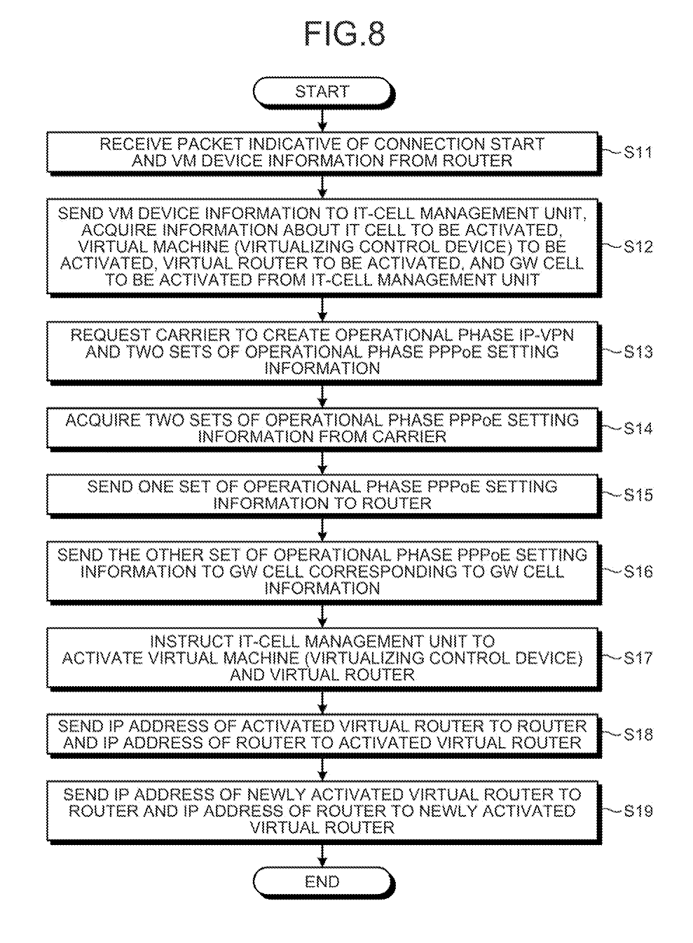

FIG. 8 is a flowchart of a process performed by the router management unit 16. The receiving unit 61 receives the packet indicative of connection start and the VM device information from the router 4 (Step S11). The acquiring unit 63 sends the VM device information to the IT-cell management unit 15. The acquiring unit 63 then acquires information about the virtual machine to be activated, information about the virtual router to be activated, information about the IT cell to be activated, and information about the GW cell to be activated from the IT-cell management unit 15 (Step S12). The virtual machine to be activated is the virtual machine 17 that activates the virtualizing control device 19a. The virtual router to be activated is the virtual router 18 that is connected to the virtual machine 17 that activates the virtualizing control device 19a. The IT cell to be activated is the IT cell 11 that includes the virtual machine 17 that activates the virtualizing control device 19a.

The requesting unit 62 requests the carrier to create the operational phase IP-VPN and two sets of the operational phase PPPoE setting information (Step S13). More particularly, the requesting unit 62 accesses the site of the carrier (e.g., “FLET'S VPN Wide setting menu of FLET'S HIKARI NEXT application page”) and sends the request. At the process of Step S13, the administrator of the VM service data center 2 can request the carrier to create the operational phase IP-VPN and two sets of the operational phase PPPoE setting information. After that, the carrier creates the operational phase IP-VPN.

The acquiring unit 63 acquires two sets of the operational phase PPPoE setting information from the carrier (Step S14). The sending unit 65 then sends one set of the operational phase PPPoE setting information to the router 4 (Step S15). After Step S15, the PPPoE processing unit 77 of the router 4 builds, using the operational phase PPPoE setting information, a communication path to the GW cell 12 corresponding to the GW cell information that has been acquired at Step S12. The sending unit 65 sends the other set of the operational phase PPPoE setting information to the GW cell corresponding to the GW cell information that has been acquired at Step S12 (Step S16). After Step S16, the GW cell 12 corresponding to the GW cell information that has been acquired at Step S12 builds a communication path to the router 4 using the operational phase PPPoE setting information.

The instructing unit 64 instructs the IT-cell management unit 15 to activate the virtual machine 17 and the virtual router 18 in accordance with the information about the virtual machine 17 to be activated and the information about the virtual router 18 to be activated both having being acquired at Step S12 (Step S17). After that, the sending unit 65 sends the IP address of the activated virtual router 18 to the router 4 and the IP address of the router 4 to the activated virtual router 18 (Step S18). After Step S18, the activated virtual router 18 sets the Ethernet over IP function to on, the Ethernet over IP function being the function of converting data into an IP packet and sending/receiving the IP packet. The activated virtual router 18 then makes communications with the router 4 via the communication path from the GW cell 12 to the router 4 in accordance with the IP address of the router 4. The router 4 sets the Ethernet over IP function to on, the Ethernet over IP function being the function of converting data into an IP packet and sending/receiving the IP packet. The router 4 then makes communications with the activated virtual router 18 via the communication path from the GW cell 12 to the router 4 in accordance with the IP address of the virtual router 18.

As an effect of the processes from Steps S11 to S18, the router management unit 16 can help the server 7 to access the virtual machine 17 that activates the virtualizing control device 19a via the router 4, the PPPoE network 3 (IP-VPN), the GW cell 12, and the virtual router 18.

After that, the sending unit 65 sends the IP address of a virtual router 18 newly activated in accordance with the VM device information specified by the router to the router 4. The sending unit 65 then sends the IP address of the router 4 to the newly activated virtual router 18 (Step S19). After Step S19, the newly activated virtual router 18 sets the Ethernet over IP function to on, the Ethernet over IP function being the function of converting data into an IP packet and sending/receiving the IP packet. The newly activated virtual router 18 makes communications with the router 4 via the communication path from the GW cell 12 to the router 4 in accordance with the IP address of the router 4. The router 4 sets the Ethernet over IP function to on, the Ethernet over IP function being the function of converting data into an IP packet and sending/receiving the IP packet. The router 4 then makes communications with the newly activated virtual router 18 via the communication path from the GW cell 12 to the router 4 in accordance with the IP address of the newly activated virtual router 18.

As an effect of the process of Step S19, the router management unit 16 can help the server 7 to access the newly activated virtual machine 17 via the router 4, the PPPoE network 3 (IP-VPN), the GW cell 12, and the virtual router 18.

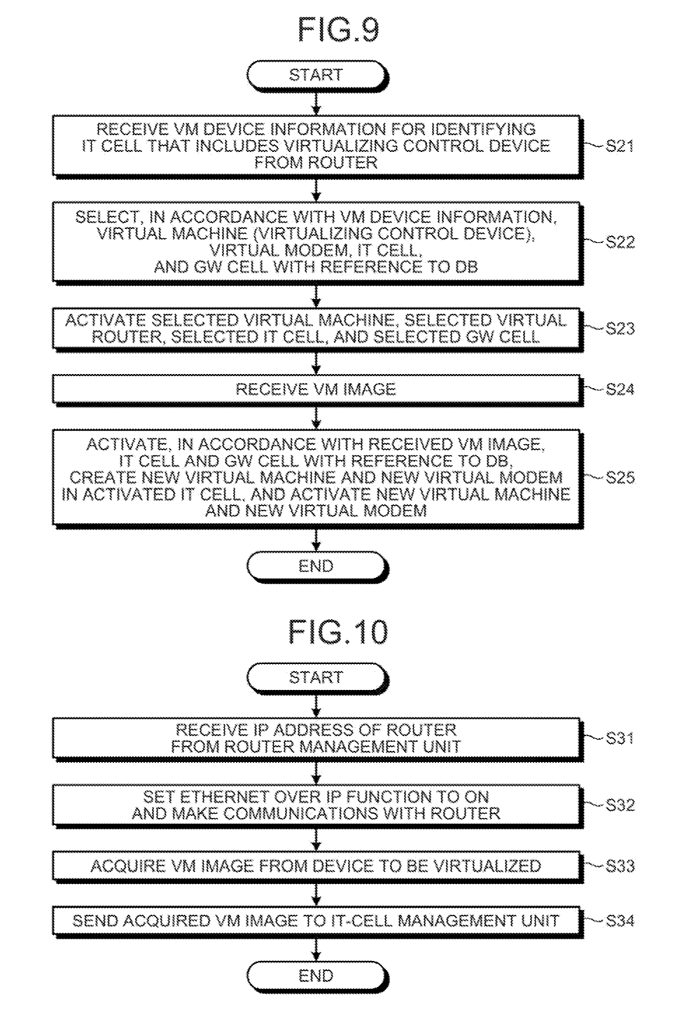

FIG. 9 is a flowchart of a process performed by the IT-cell management unit 15. At the beginning of the process, the IT-cell management unit 15 receives, from the router 4 via the router management unit 16, the VM device information for identifying the IT cell 11 that includes the virtualizing control device 19a (Step S21). The IT-cell management unit 15 selects, in accordance with the received VM device information, the virtual machine 17, the virtual router 18, the IT cell 11, and the GW cell 12 with reference to the DB 15A (Step S22). The selected virtual machine 17 is the virtual machine that activates the virtualizing control device 19a. The selected virtual router 18 is the virtual router that is connected to the virtual machine 17 that activates the virtualizing control device 19a. The selected IT cell 11 is the IT cell that includes the virtual machine that activates the virtualizing control device 19a and the virtual router that is connected to the virtual machine. The IT-cell management unit 15 activates the selected virtual machine 17, the selected virtual router 18, the selected IT cell 11, and the selected GW cell 12 (Step S23).

After that, the IT-cell management unit 15 receives the VM image from the server 7 via the IT cell 11 that includes the virtualizing control device 19a (Step S24). This VM image is information created by the server 7 and contains the VM device information assigned to the server 7. The IT-cell management unit 15 activates, in accordance with the received VM image, the IT cell 11 and the GW cell 12 with reference to the DB 15A. The IT-cell management unit 15 then creates a new virtual machine 17 and a new virtual router 18 in the activated IT cell 11 and activates the new virtual machine 17 and the new virtual router 18 (Step S25).

According the present process, the IT-cell management unit 15 activates the virtual machine 17 that activates the virtualizing control device 19a in accordance with the VM device information for identifying the IT cell 11 that includes the virtualizing control device 19a, which enables the IT-cell management unit 15 to receive the VM image that includes the VM device information from the server 7. This also enables the IT-cell management unit 15 to create a new virtual machine and a new virtual router in accordance with the VM device information that is included in the VM image of the server 7 and activate the new virtual machine and the new virtual router.

FIG. 10 is a flowchart of a process performed by the IT cell 11 that includes the virtual machine 17 that activates the virtualizing control device 19a. It is assumed that the virtual machine 17 that activates the virtualizing control device 19a and the IT cell 11 that includes the virtual router 18 are being activated.

The virtual router 18 included in the IT cell 11 receives the IP address of the router 4 from the router management unit 16 (Step S31). The virtual router 18 sets the Ethernet over IP function to on, the Ethernet over IP function being the function of converting data into an IP packet and sending/receiving the IP packet. The virtual router 18 then makes communications with the router 4 via the communication path from the GW cell to the router 4 in accordance with the IP address of the router 4 (Step S32).

The virtualizing control device 19a acquires the VM image from the server 7 via the router 4 (Step S33). The server 7 is a device to be virtualized. The virtualizing control device 19a sends the VM device information that is included in the VM image to the IT-cell management unit 15 (Step S34). The IT-cell management unit 15 then selects, in accordance with the received VM device information, the IT cell 11 and the GW cell 12 with reference to the DB 15A, creates a new virtual machine 17 and a new virtual router 18 in the selected IT cell 11, and activates the new virtual machine 17 and the new virtual router 18.

In this example, the virtualizing control device 19a is implemented when the CPU 51 of the IT cell 11 executes predetermined software (e.g., a virtual machine application).

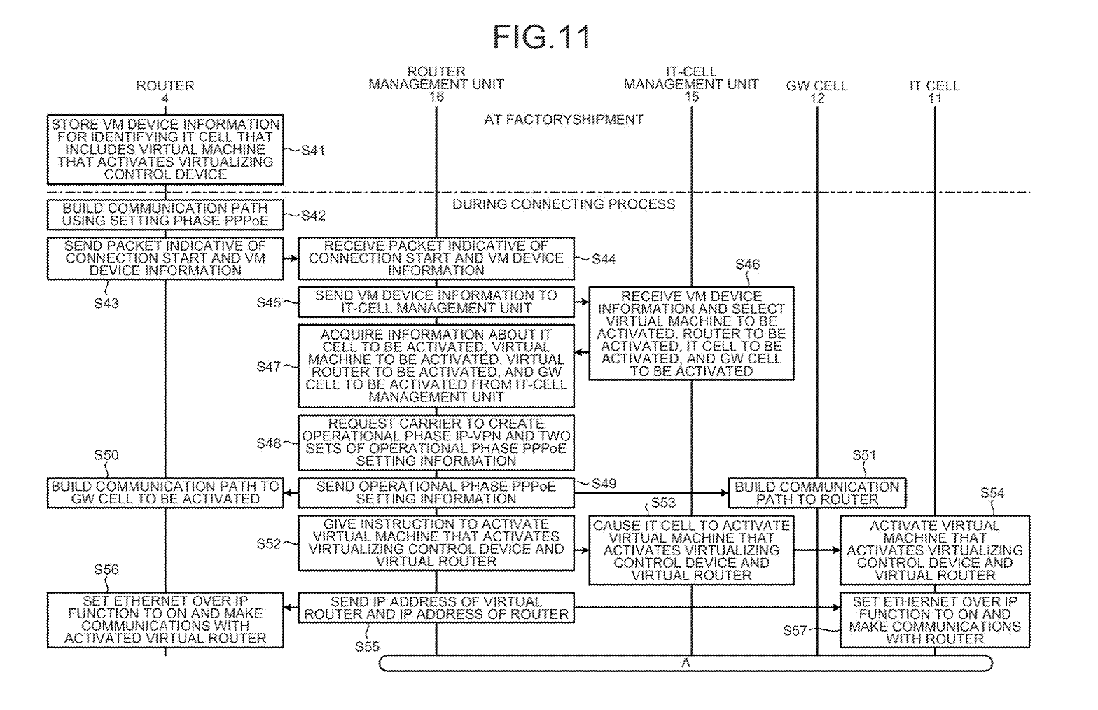

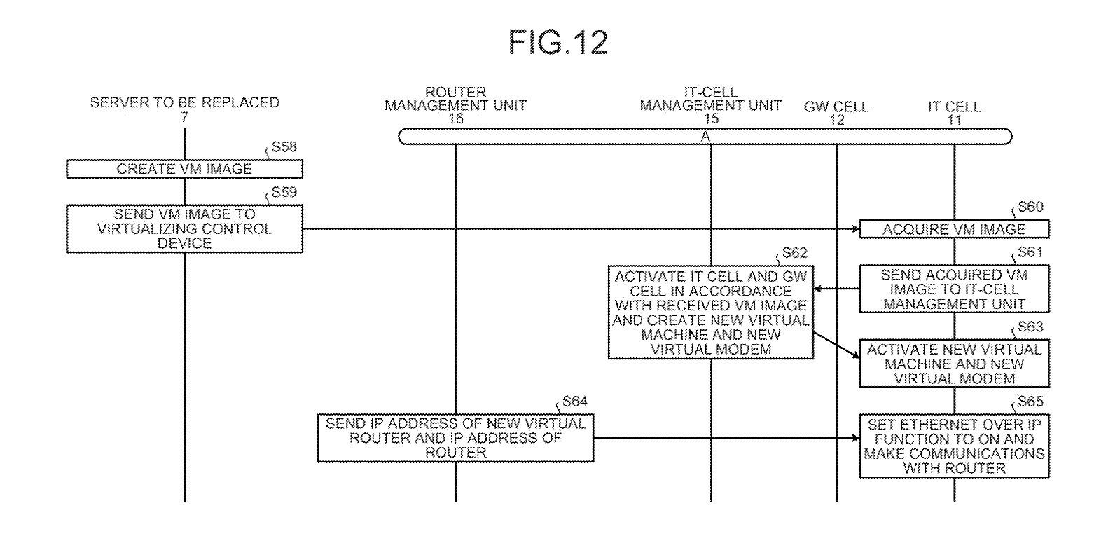

FIGS. 11 and 12 are a sequence diagram of a process performed by the information management system 1. The VM device information for identifying the IT cell 11 that includes the virtual machine 17 that activates the virtualizing control device 19a is stored in the memory 72 of the router 4 as the factory default (Step S41). During the router 4 connecting process, the PPPoE processing unit 77 of the router 4 builds a setting-phase-PPPoE-based communication path to the GW cell 12 using the setting phase PPPoE setting information that is stored in the PPPoE authentication information DB 79 (Step S42). The PPPoE processing unit 77 of the router 4 sends the packet indicative of connection start and the VM device information to the router management unit 16 (Step S43).

The router management unit 16 receives the packet indicative of connection start and the VM device information from the router 4 (Step S44). The router management unit 16 sends the VM device information to the IT-cell management unit 15 (Step S45). The IT-cell management unit 15 receives the VM device information and selects the virtual machine 17 to be activated, the virtual router 18 to be activated, the IT cell 11 to be activated, and the GW cell 12 to be activated (Step S46). The virtual machine 17 to be activated is the virtual machine that activates the virtualizing control device 19a.

The router management unit 16 then acquires information about the virtual machine 17 to be activated, information about the virtual router 18 to be activated, information about the IT cell 11 to be activated, and information about the GW cell 12 to be activated from the IT-cell management unit 15 (Step S47). The router management unit 16 requests the carrier to create the operational phase IP-VPN and two sets of the operational phase PPPoE setting information (Step S48). The carrier builds, in response to the request from the router management unit 16, the operational phase IP-VPN and sends two sets of the operational phase PPPoE setting information to the router management unit 16. The router management unit 16 sends one set of the operational phase PPPoE setting information to the router 4, and the other set of the operational phase PPPoE setting information to the GW cell to be activated (Step S49).

The PPPoE processing unit 77 of the router 4 builds a communication path to the GW cell 12 to be activated using the operational phase PPPoE setting information (Step S50). The GW cell 12 to be activated builds a communication path to the router 4 using the operational phase PPPoE setting information (Step S51). As an effect of Steps S50 and S51, the router 4 and the GW cell 12 to be activated are connected to each other via the Ethernet-based virtual private network.

After that, the router management unit 16 instructs the IT-cell management unit 15 to activate the virtual machine 17 and the virtual router 18 in accordance with the information about the virtual machine 17 to be activated and the information about the virtual router 18 to be activated, both having been acquired at Step S47 (Step S52). The IT-cell management unit 15 causes the IT cell 11 to be activated to activate the virtual machine 17 to be activated, i.e., the virtual machine 17 that activates the virtualizing control device 19a and the virtual router 18 to be activated (Step S53). The IT cell 11 that is selected by the IT-cell management unit 15 activates the virtual machine 17 that activates the virtualizing control device 19a and the virtual router 18 to be activated (Step S54).

After that, the router management unit 16 sends the IP address of the activated virtual router 18 to the router 4 and the IP address of the router 4 to the activated virtual router 18 (Step S55). The router 4 receives the IP address of the activated virtual router 18 from the router management unit 16. The router 4 sets the Ethernet over IP function on and then makes communications with the activated virtual router 18 via the communication path from the GW cell to the router 4 in accordance with the received IP address (Step S56). The activated virtual router 18 of the IT cell 11 receives the IP address of the router 4 from the router management unit 16. The activated virtual router 18 sets the Ethernet over IP function to on, the Ethernet over IP function being the function of converting data into an IP packet and sending/receiving the IP packet. At the same time, the activated virtual router 18 makes communications with the router 4 via the communication path from the GW cell to the router 4 in accordance with the received IP address (Step S57).

As an effect of the processes from Steps S41 to S57, the server 7 can make communications with the virtual machine 17 that activates the virtualizing control device 19a.

After that, the server 7 to be replaced creates the VM image that contains the VM device information about itself and the HDD image (Step S58) and sends the VM image to the virtual machine 17 that activates the virtualizing control device 19a (Step S59).

The virtualizing control device 19a acquires the VM image from the router 4 (Step S60). The virtualizing control device 19a sends the acquired VM image to the IT-cell management unit 15 (Step S61). The IT-cell management unit 15 activates, in accordance with the received VM image, the IT cell 11 and the GW cell 12 with reference to the DB 15A. The IT-cell management unit 15 then creates a new virtual machine 17 and a new virtual router 18 in the activated IT cell 11 and activates the new virtual machine 17 and the new virtual router 18 (Step S62). Thus, the new virtual machine 17 and the new virtual router 18 are activated (Step S63).

After that, the router management unit 16 sends the IP address of a newly activated virtual router 18 to the router 4 and the IP address of the router 4 to the newly activated virtual router 18 (Step S64). The router 4 receives the IP address of the newly activated virtual router 18 from the router management unit 16. The router 4 sets the Ethernet over IP function on and then makes communications with the newly activated virtual router 18 in accordance with the received IP address.

The newly activated virtual router 18 included in the IT cell 11 receives the IP address of the router 4 from the router management unit 16. The newly activated virtual router 18 sets the Ethernet over IP function on and then makes communications with the router 4 in accordance with the received IP address (Step S65).

As an effect of the processes from Steps S58 to S65, the server 7 is replaced with the virtual machine and the client PC 6 can receive the service that is provided by the existing server 7 from the virtual machine.

Summary of Second Embodiment

As described above, according to the second embodiment, the virtualizing control device 19a that is activated on the virtual machine 17 included in the IT cell 11 receives information about the server 7, creates a new virtual machine and a new virtual router, and replaces the server 7 with the new virtual machine. Thus, the existing server is easily replaced with the virtual machine.

It is allowable to provide the IT cell 11 with a recording medium that stores therein a program for implementing the functions of the IT cell 11 that includes the virtualizing control device 19a and cause the CPU 51 of the IT cell 11 to execute the program that is stored in the recording medium. It is also allowable to provide the management server 14 with a recording medium that stores therein a program for implementing the functions of the IT-cell management unit 15 or the router management unit 16 and cause the CPU 51 of the management server 14 to execute the program that is stored in the recording medium. The recording medium that provides these programs can be, for example, a compact disk read only memory (CD-ROM), a digital versatile disk (DVD), a secure digital (SD) memory card, and etc.

The same effects as the above embodiments can be achieved when the CPU 51 of the IT cell 11 executes a software program for implementing the functions of the virtualizing control device 19a, the virtual machine 17, and the virtual router 18. The same effects can be achieved when the CPU 51 of the management server 14 executes a software program for implementing the functions of the IT-cell management unit 15 or the router management unit 16.

According to a network system, a process-providing-server switching method, a process-providing-server switching program, an information processing apparatus, a virtual-machine building method, and a virtual-machine building program according to an embodiment of the present application, it is possible to easily replace an existing server with a virtual machine.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A network system comprising:
a router that performs routing between a virtual private network and a local network;
an information creating unit that creates information related to a process that is provided by a local server, the local server being connected to the local network;
a sending unit that sends the information created by the information creating unit via the router; and
a virtual-private server that receives the information and provides the process that is provided by the local server via the virtual private network.

2. The network system according to claim 1, wherein the information creating unit creates at least any one of information about a hardware resource included in the local server, information about an operating system of the local server, and information about data that is stored in the local server.

3. The network system according to claim 1, wherein
the sending unit sends the information to a device that has a predetermined network address, and
the device that receives the information builds a virtual machine that provides the process that is provided by the local server and sets the virtual machine to be the virtual-private server.

4. A process-providing-server switching method comprising:
creating information related to a process that is provided by a local server, the local server being connected to a local network;
sending the created information via a router that performs routing between a virtual private network and the local network; and
receiving the information and providing the process that is provided by the local server via the virtual private network.

5. A computer-readable, non-transitory medium storing a process-providing-server switching program that causes a computer to execute a process comprising:
creating information related to a process that is provided on a local network by the computer that executes the process-providing-server switching program; and
sending the created information to a predetermined device that is connected to a virtual private network.

6. An information processing apparatus comprising:
a receiving unit that receives information related to a process from a router connected via a virtual private network, the process being provided on a local network by a server that is connected via the router;
a virtual-machine management unit that builds a virtual machine that provides the process that is provided by the local server; and
a sending unit that sends information about the virtual machine to the router.

7. A virtual-machine building method comprising:
receiving information related to a process from a router connected via a virtual private network, the process being provided on a local network by a server that is connected via the router;
building a virtual machine that provides the process that is provided by the local server; and
sending information about the virtual machine to the router.

8. A computer-readable, non-transitory medium storing a virtual-machine building program which causes a computer to execute a process comprising:
receiving information related to a process from a router connected via a virtual private network, the process being provided on a local network by a server that is connected via the router;
building a virtual machine that provides the process that is provided by the local server; and
sending information about the virtual machine to the router.
